(19) United States
(12) Patent Application Publication
(10) Pub. No.: US 2025/0180343 A1
(43) Pub. Date: Jun. 5, 2025

(54) Digital linear measuring device calibration

(71) Applicant: Reekon Tools Inc., East Boston, MA (US)

(72) Inventors: Colton Black, Westford, MA (US); Konstantinos Oikonomopoulos, Boston, MA (US); Christian Reed, Chelsea, MA (US); Harrison White, Somerville, MA (US)

(21) Appl. No.: 18/526,661

(22) Filed: Dec. 1, 2023

(51) Int. Cl. G01B 3/1069; G01B 3/1084

(52) U.S. Cl. CPC G01B 3/1069; G01B 3/1084

(57) ABSTRACT

A digital linear measuring device incorporates a tape measure calibration functionality. This functionality provides a calibration procedure that is used to remove errors and increase accuracy and/or repeatability of the overall device. The procedure corrects for both fixed errors (if the tape measure tip is bent) as well as scaler errors (the measuring pattern slowly increases in size over length of tape measure). This allows the device to compensate for printing errors, physical damage to the tape measure, as well as ensure digital and physical markings consistently are aligned and accurate relative to one another.

### BACKGROUND

### Technical Field

This disclosure relates generally to measuring devices and methods.

### Related Art

It is known in the prior art to augment a conventional tape measure device with measuring and processing components that enable greater accuracy to the measurements made by the device. One such example is Crane U.S. Pat. No. 5,142,793, which describes a digital tape measure device that comprises a housing, a reel located within a housing and a measuring tape wound on the reel. The measuring tape is extendable through an opening in the housing as the reel is rotated. An incremental measuring mechanism is associated with the reel for generating incremental measuring data. In addition, the device also includes an absolute measuring mechanism. The absolute measuring mechanism cooperates with the measuring tape for generating absolute measurement data as the measuring tape is extended. A processing unit is responsive to both the incremental measurement data and to the absolute measurement data for generating an output reflecting linear extension of the measuring tape from the housing, and a display is responsive to the processing unit for displaying information reflecting the linear extension of the measuring tape from the housing.

In the process of linear measuring, there are many potential sources of error when trying to capture a correct measurement. Whether these errors relate to accuracy or precision, they can have adverse effects on the results of a measurement. These sources of error may come from many places and are often the result of noise in a system, compounding errors, physical printing, or misinterpretation of data. While a fully analog system is largely dependent on human interpretation, a digital encoding system, like one found on a digital tape measure, may have many causes of inaccurate results.

### BRIEF SUMMARY

This disclosure describes a digital linear measuring device (e.g., a tape measure) that incorporates a tape measure calibration functionality. This functionality provides a calibration procedure that is used to remove errors and increase accuracy and/or repeatability of the overall device. The procedure corrects for both fixed errors (e.g., if the tape measure tip is bent) as well as scaler errors (e.g., because the measuring pattern slowly increases in size over length of tape measure). This allows the device to compensate for printing errors, physical damage to the tape measure, as well as ensure digital and physical markings consistently are aligned and accurate relative to one another.

In one embodiment, the device has a housing that supports a display on which measurements are rendered. To take a measurement, a tape measure is extended from the housing at a given distance of interest. The tape measure includes unit length markings. The device housing supports a positional encoder, a processor, and memory/storage that supports control software executed by the processor to control the device. In particular, the control software is configured to process positional information received from the positional encoder, compute a linear location of the measuring tape (its degree of extension from the housing, as measured by the unit length markings), and to generate one or more control signals to drive the display to render positional data. According to this disclosure, the above-described processing is augmented to adjust an accuracy of the positional data displayed to the user, using a calibration procedure.

The calibration procedure involves receiving a set of positional information from the positional encoder. The set of positional information is generated according to a calibration protocol. Preferably, this protocol comprises a set of readings (measurements) taken with the measuring tape at two or more fixed reference points, and wherein each of the fixed reference points are distinct from one another. For each fixed reference point, an expected position is then calculated. The expected positions of the fixed reference points are then averaged to generate an average expected distance between a unit length pair of reference points, e.g., the reference point “1” (the measuring tape positioned at the 1 inch mark) and “0” (the measuring tape unextended from the housing), the reference points “2” and “1”, reference points “3” and “2,” and so forth. Preferably, the system also checks to determine (and verify) that the average expected distance between the pair of the fixed reference points is consistent over an entire length of the tape measure. The average expected distance between the unit length pair of reference points is then saved by the device (e.g., in memory) as a calibration value. This completes the calibration procedure. The calibration value generated by the calibration procedure is the applied by a device processor to any new positional information generated by the positional encoder as such new positional information is being processed for display. This operation ensures that the positional data that is displayed on the display then corresponds to the printed markings on the tape measure, irrespective of the physical integrity of the hook or the measure itself.

The foregoing has outlined some of the more pertinent features of the subject matter. These features should be construed to be merely illustrative. Many other beneficial results can be attained by applying the disclosed subject matter in a different manner or by modifying the subject matter as will be described.

### BRIEF DESCRIPTION OF THE DRAWINGS

FIG. 1 is a perspective view of a measuring device of this disclosure in which the techniques of this disclosure are practiced;

FIG. 2 depicts how offset and scaling errors in the tape measure contribute to measurement errors;

FIG. 3 depicts a representative blade setup calibration procedure that is implemented according to an embodiment of this disclosure;

FIG. 4 depicts a process flow of the blade setup calibration procedure of FIG. 3; and

FIG. 5 depicts how application of the described calibration technique removes errors and increases accuracy in the displayed measurement produced by the device.

### DETAILED DESCRIPTION

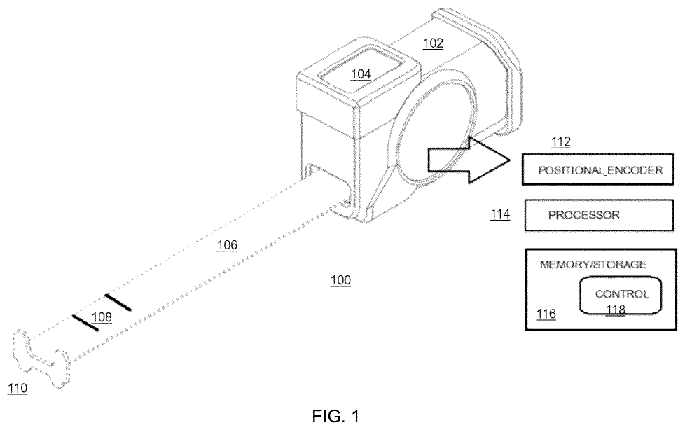

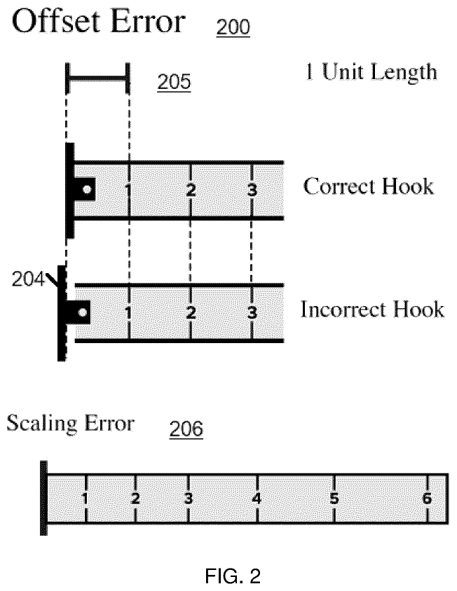

FIG. 1 depicts a typical digital tape measure device 100 in which the techniques herein may be practiced. The device 100 has a housing 102 that supports a display 104 on which measurements are rendered. To take a measurement, a tape measure 106 is extended from the housing 102 at a given distance of interest. The tape measure 106 includes unit length markings 108, and terminates in a hook or similar end structure 110. The tape measure 106 extends from a reel (not shown) positioned within the housing. As further depicted, the housing also supports a positional encoder 112, a processor 114, and memory/storage 116 that supports control software 118 executed by the processor 114 to control the operations and functions of the device. In particular, the control software 118 executed by the processor 114 is configured to process positional information received from the positional encoder 112, compute a linear location of the measuring tape (in other words, its degree of extension from the housing, as measured by the unit length markings), and to generate one or more control signals to drive the display 104 and, in particular, to render positional data on the display. Given a tape measure that exhibits no fixed or scalar errors, the positional data (the measurement) rendered on the display exactly matches the unit length measurements indicated on the tape measure. In other words, the analog (physical) measurement corresponds precisely to the displayed digital measurement value. As noted above, however, such precise alignment is difficult to obtain due to the error sources described. FIG. 2 depicts these common errors. For example, an offset error 200 occurs when there is some defect in the hook 202 of the tape measure. As shown in the example, and due to the mechanical defect in the hook, the actual unit length for the tape measure 204 is incorrect. Another type of error is a scaling error 206, which is caused by a defect in the printing of the unit length markings themselves, or some other mechanical failure in the tape measure. As shown in this exaggerated example, the unit markings begin to deviate along the length of the measure as the distance from the hook increases such that the unit length is no longer correct.

According to this disclosure, the device control processing is enhanced to adjust the accuracy of the positional data that is displayed to the user on the display so as to compensate for these error sources, as well as any other error that causes a mismatch between the analog reading and the resulting positional data that is actually displayed. This functionality, which is also referred to as device or tape measure calibration, is now described.

At a high level, the calibration procedure herein involves receiving a set of positional information from the positional encoder 112, wherein the set of positional information is generated according to a calibration protocol. Preferably, this protocol comprises a set of readings (measurements) taken with the measuring tape at two or more fixed reference points, and wherein each of the fixed reference points are distinct from one another. For each fixed reference point, an expected position is then calculated. The expected positions of the fixed reference points are then averaged to generate an average expected distance between a unit length pair of reference points, e.g., the reference point “1” (the measuring tape positioned at the 1 inch mark) and “0” (the measuring tape unextended from the housing), the reference points “2” and “1”, reference points “3” and “2,” and so forth. The average expected distance between the unit length pair of reference points is then saved by the device (e.g., in memory) as a calibration value. This completes the calibration procedure. The calibration value generated by the calibration procedure is the applied by the device processor to any new positional information generated by the positional encoder as such new positional information is being processed for display. This operation ensures that the positional data that is displayed on the display corresponds to (matches) the tape measure's analog marking, irrespective of any physical defects or errors in the measuring tape itself.

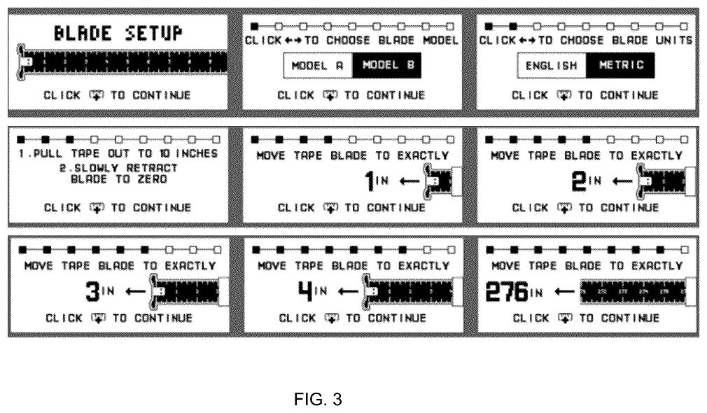

FIG. 3 depicts a set of display prompts that may be provided to the user to perform the calibration or blade setup. This procedure may be carried out when the device is first used, when batteries within the device are replaced, when the user has reason to question the accuracy of the displayed readings, or otherwise. Indeed, the procedure may be executed upon each power-up of the device. At display prompt (1), the user is prompted to click to continue the process. At prompt (2), the user is prompted to select a blade model. This prompt may be omitted if there is only one model At prompt (3), the user is prompted to choose the blade units (e.g., English, or metric). At prompt (4), the user is prompted to pull the tape out to a given distance (e.g., 10 inches), and then to retract the blade back into the housing. This enables the system to identify the “0” value. At prompt (5), the user is prompted to move the tape blade to exactly “1” inch as indicated by the unit length marking on the tape. This enables the system to identify the “1” value. After the system records the measurement, and at prompt (6), the user is prompted to move the tape blade to exactly “2” inches as indicated by the unit length marking on the tape. This enables the system to identify the “2” value. After the system records the measurement, and at prompt (7), the user is prompted to move the tape blade to exactly “3” inches as indicated by the unit length marking on the tape. This enables the system to identify the “3” value. After the system records the measurement, and at prompt (8), the user is prompted to move the tape blade to exactly “4” inches as indicated by the unit length marking on the tape. This enables the system to identify the “4” value. After the system records the measurement, and finally at prompt (9), the user is prompted to withdraw the tape measure to its full extent, in this example the “276” inch position. This enables the system to identify the “276” value. Each of the above-identified measurement points correspond to the “fixed reference points” identified above.

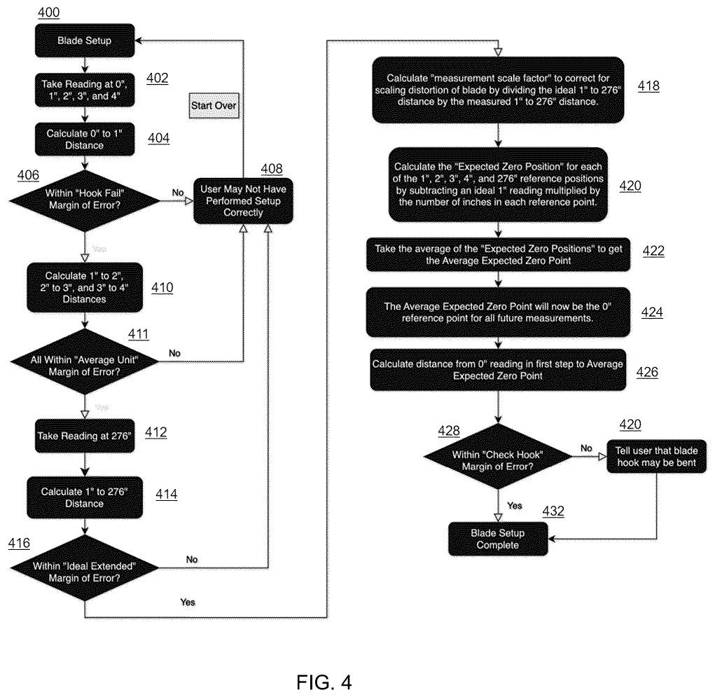

FIG. 4 depicts a process flow for generating the calibration value from the measurements collected by the device during the above-described prompting. The blade setup routine begins at step 400. At step 402, the “0,” “1,” “2,” “3,” and “4” readings are taken. This corresponds to prompts (4) through (8). At step 404, and based on the positional data captured as a result of prompts (4) and (5), the distance between “0” and “1” is computed. A test is then performed at step 406 to determine if the resulting computed distance is within a “hook fail” margin of error. If not, the user may not have performed the setup correctly (based on those prompts) as indicated by step 408, in which case control is returned back to step 400. If the computed distance is within the hook fail margin of error, control continues at step 410 to calculate the “1” to “2” distance, the “2” to “3” distance, and the “3” to “4” distance, once again using the positional data captured as a result of the prompts (6) through (8). At step 411, a test is performed to determine whether the results of the calculations done in step 410 are all within an “average unit” margin of error. If not, then controls returns back to step 400 for the blade setup process to be re-started. If the computation results, however, are within the average unit margin of error, as indicated by a positive outcome of the test at step 411, control then continues at step 412. Step 412 represents the system taking the reading at full extension of the tape measure, corresponding to prompt (9). At step 414, a “1” to “276” distance is computed (with the value “276” here being representative of the fully-extended tape measure). At step 416, a test is then performed to determine whether the value computed at step 414 is within an “ideal extended” margin of error. If not, once again control is returned to re-start the calibration procedure. If the value computed at step 414 is within the margin of error, however, the calibration process continues at step 418.

At step 418, the system calculates a “measurement scale factor” to correct for scaling distortion of the blade. This factor is computed by dividing the ideal [“1” to “276”] computed at step 414 by the measured [“1” to “276”] distance obtained as a result of prompt (9). At step 420, the system calculates an “expected zero position” for each of the “1,” “2,” “3,” “4” and “276” fixed reference points by subtracting an ideal “1” reading multiplied by the number of inches in each such fixed reference point. At step 422, an average of the “expected zero positions” is then taken to obtain an “average expected zero point.” At step 424, the average expected zero point is then set as the calibration value, namely, the “0” reference point for future measurements (until the calibration procedure is re-done, for whatever reason). To complete the process, the system performs a final check on the hook. To this end, at step 426 the system calculates the distance from the “0” reading (taken at step 402) to the average expected zero point (i.e., the calibration value). A test is then performed at step 428 to determine whether the value computed at step 426 is within a “check hook” margin of error. If not, and at step 430, the user is notified (e.g., on the display) that the blade hook may be bent. If the outcome of the test at step 428 is positive, the blade setup is complete, as indicated at step 432. At this step, the calibration value is saved within the device memory or storage for application to any new positional data.

The particular operations identified in FIG. 4 may be carried in other sequences. Also, there may be fewer prompts (and thus fewer of the above-described computations), or more prompts (at additional locations). The above-described procedure thus is merely representative.

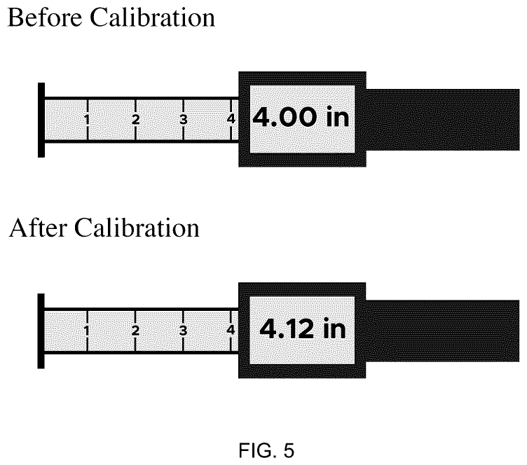

FIG. 5 depicts a result of applying the calibration value to a new measurement. At the top, and before the calibration procedure is run, there is a clear visual discrepancy between the unit length marking and the displayed measurement. After calibration, however, the analog and digital values are aligned, despite whatever anomaly exists in the tape measure.

Thus, and according to this disclosure, the user turns on the device and enters the calibration procedure by following the prompts on the display screen. As the user responds to the prompts, the device records each position's digital reading (digital and analog signals taken from device sensors) to correlate to expected values (with the assumption user moved the tape to the prompted positions). Once data is recorded from the prompting, the positional data generated is compiled. The algorithm as depicted in FIG. 4 and described above then checks that the procedure was performed correctly by the user. If so, the procedure then compares initial readings taken from near the beginning of tape measure to readings taken near the end of the tape measure and compares the resulting digital signals to confirm that calibration was successful. After the data points are compiled and the calibration value is generated, offset and scaling compensation is then automatically applied to digital measurements to compensate for the offset and/or scaling errors.

Further details regarding the digital measure device in which the techniques herein are practiced may be found in U.S. Pat. No. 11,460,284, the disclosure of which is hereby incorporated by reference.

The device may also be controlled, e.g., over-the-air, or directly via wired connection, by an external tool or device. Also, measurements may be transmitted, either over-the-air, or over that direct connection, to some external device or system, such as a smart phone, smart watch, other computing device, or other “smart” work tool.

The described control functionality may be practiced, typically in software, on one or more hardware processors, in firmware, or via other controllers. Generalizing, a microcontroller typically comprises commodity hardware and software, storage (e.g., disks, disk arrays, and the like) and memory (RAM, ROM, and the like), network interfaces and software to connect the machine to a network in the usual manner, and the like.

While the above describes a particular order of operations performed by certain embodiments of the invention, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

While given components of the system have been described separately, one of ordinary skill will appreciate that some of the functions may be combined or shared in given instructions, program sequences, code portions, and the like.

Having described the subject matter, what we now claim is set forth below.

1. A digital linear measuring device having a measuring tape with unit length markings, comprising:
a positional encoder;
a display; and
a processor configured by software to process positional information received from the positional encoder, compute a linear location of the measuring tape, and generate a control signal to drive the display;
the processor being further configured to adjust an accuracy of positional data displayed by the device by:
receiving a set of positional information from the positional encoder, the set of positional information having been generated according to a calibration protocol, the calibration protocol comprising a set of readings taken with the measuring tape at two or more fixed reference points;
for each fixed reference point, calculating an expected position; and
averaging the expected positions of the fixed reference points to generate an average expected distance between a pair of the fixed reference points; and
saving the average expected distance between the pair of the fixed reference points as a calibration value; and
thereafter applying the calibration value to positional information received from the positional encoder to generate a new control signal that drives the display.

2. The digital linear measuring device as described in claim 1, further including using the new control signal to display a new measurement associated with a new reading, wherein the new measurement matches unit length markings on the measuring tape.

3. The digital linear measuring device as described in claim 1, wherein the set of fixed reference points include the measuring tape in a non-extended position, and in a fully-extended position.

4. The digital linear measuring device as described in claim 1, wherein the set of fixed reference points of the calibration protocol include the measuring tape at one of: a “0” unit length corresponding to the measuring tape being unextended, and a “1 to n” unit length, wherein n is a maximum unit length along the measuring tape.

5. The digital linear measuring device as described in claim 4, wherein the fixed reference points are unit lengths of “0,” the maximum unit length along the measuring tape, and at least one of: “1,” “2,” “3” and “4,” and wherein, for each such fixed reference point and its associated positional information, the expected position for such fixed reference point is computed by subtracting from the associated positional information a value equal to a number of unit lengths of such fixed reference point times a constant.

6. The digital linear measuring device as described in claim 5, wherein the constant is a fixed unit length value.

7. The digital linear measuring device as described in claim 1, wherein the calibration protocol generates the calibration value to compensate for an offset error associated with the measuring tape.

8. The digital linear measuring device as described in claim 7, wherein the measuring tape include a hook, wherein the offset error is caused by a defect in the hook or its attachment to the measuring tape.

9. The digital linear measuring device as described in claim 1, wherein the calibration protocol generates the calibration value to compensate for a scaling error associated with the measuring tape.

10. The digital linear measuring device as described in claim 9, wherein the scaling error is caused by a defect in one or more printed markings on the measuring tape.

11. The digital linear measuring device as described in claim 1, wherein one or more of the set of readings identified in the calibration protocol are initiated by a display prompt.

12. The digital linear measuring device as described in claim 1, wherein each of the fixed reference points are distinct from one another.

13. The digital linear measuring device as described in claim 1, further including verifying that the average expected distance between the pair of the fixed reference points is consistent over an entire length of the tape measure.
